(19) United States
(12) Patent Application Publication
(10) Pub. No.: US 2003/0167923 A1
(43) Pub. Date: Sep. 11, 2003

(54) Tank for the reversible storage of hydrogen

(76) Inventors: Frank Grote, Aachen (DE); Peter Busse, Aachen (DE); Volker Guther, Burgthann (DE); Andreas Otto, Rosstal (DE)

Correspondence Address: BIRCH STEWART KOLASCH & BIRCH, PO BOX 747, FALLS CHURCH, VA, 22040-0747, US

(21) Appl. No.: 10/275,650

(22) PCT Filed: May 10, 2001
(86) PCT No.: PCT/EP01/05361

(51) Int. Cl. B01D 53/02

(52) U.S. Cl. 96/108

(57) ABSTRACT

The invention relates to a tank for the reversible storage of hydrogen, comprising an external pressure casing, a hydrogen-storage alloy contained therein, a heat-exchange system and a hydrogen-gas reservoir, which is characterized in that, for the absorption of the hydrogen-storage alloy, the tank has a bed which consists of an open-pored metal sponge connected to the pressure-vessel wall in a material fit.

The invention relates to a tank for the reversible storage of hydrogen, which comprises an external pressure casing, a hydrogen-storage alloy contained therein, a heat-exchange system and a hydrogen-gas reservoir.

As a universal, reversibly producible energy source, hydrogen plays a prominent role in the debate concerning the future systems for energy provision. Part of future hydrogen-energy management is the storage of hydrogen after its production (e.g. by electrolysis of water) and the provision of hydrogen as a combustion gas (e.g. for combustion engines or fuel cells).

The following three systems are regarded as technically proven for the storage of hydrogen:

Storage in compressed-gas tanks (compressed, gaseous hydrogen)

Storage in cryogenic tanks (very low-temperature liquefied hydrogen).

Storage in metal alloys (hydrogen chemically bonded to metals)

Storage in defined geometric structures made from carbon fibres (nanotubes) is still in an early stage of development and to date has not been proven on an industrial scale.

All three possible storage methods have specific advantages and disadvantages, of which the most important are listed in the following table:

| | Advantages | Disadvantages |
|---|---|---|
| Compressed gas | gravimetric energy | volumetric energy |
| | density, loading | density, potential |
| | and unloading | hazards; |
| | time; | |
| Liquid gas | energy densities; | energy outlay for |
| | | liquefaction and |
| | | cooling; |
| Metal alloy | volumetric energy | gravimetric energy |
| | density, low | density, |
| | pressure level, | absorption and |
| | safety; | desorption rates, |
| | | heat management; |

Tanks with water-storage alloys have been known for more than 25 years and consist of the following basic components, the practical configuration of which depends on the respective conditions of use:

Metal-alloy bed

→loose powder fill in pressure vessels

→powder, shot, ingots in cassettes in pressure vessels

→mixture of powder/shot with metal-alloy powder to improve their heat conductivity

→compacted powder/shot with binder systems

External pressure vessel around the metal-alloy bed

→cylindrical tubes with dished bottoms

→flat geometries with small external dimensions

Heat exchange system (external and/or internal)

→systems for improving heat conduction in the pressure vessel

→cooling/heating coils in the pressure vessel

→cooling/heating of the pressure-vessel wall from outside

→gases, liquids as heat-exchange means

Hydrogen reservoir

→finely porous tubes (<0.5 μm pore size) in the pressure vessel.

Larger tanks with hydrogen-storage alloys are obtained by joining together individual, smaller units.

Hydrogen-storage alloys are characterized in that the absorption and release of the hydrogen take place in each case at an equilibrium pressure which is typical of the working temperature. During absorption, the formation heat of the metal hydride must be removed from the system (exothermic reaction), because otherwise the metal-alloy bed heats up and the equilibrium pressure (absorption) moves upward. Conversely, heat must be supplied during desorption because otherwise the metal-alloy bed freezes up and the equilibrium pressure (desorption) falls.

In practice, the so-called cassette technique, as described by H. Buchner, “Energiespeicherung in Metallhydriden; Innovative Energietechnik” [Energy Storage in Metal Hydrides; Innovative Energy Technology], Springer-Verlag, Vienna, New York, 1992, has gained acceptance for tanks in which high sorption rates are required. The heat of reaction is transferred by heat conduction over an extensive area via the walls of the pressure vessel and the cassettes to a metal-alloy bed of small thickness, so that the poor heat conduction of the metal-alloy bed has a less markedly limiting effect. For tanks with a low desorption rate, powder fills of metal alloys in corresponding pressure vessels are customarily used, the heats of reaction being supplied or removed via the walls of the pressure vessel and heat conduction in the metal-alloy bed.

Tanks with hydrogen-storage alloys are basically pressure vessels and are subject to the corresponding regulations. The design must not only correspond to the preferred working range of the metal alloy, but must also take into account all conceivable conditions. This becomes a problem if a tank already having a relatively low temperature is to have a high desorption pressure, but the external temperature can quite easily also become clearly higher. An example that may be cited is a tank for a motor vehicle with a combustion engine which at 0° C. is to provide hydrogen with a pressure of 2 bar. Given a possible maximum temperature of 80° C., an equilibrium pressure of roughly 70 bar would be established in the tank, which must accordingly have a pressure-resistant design.

The decisive disadvantage of tanks with hydrogen-storage alloys is the low gravimetric energy density which on the one hand is caused by the active metal hydride, but also by the pressure vessel and heat-exchange systems. Thus the tank described by H. Buchner (see above) from the Daimler Benz fleet trial in Berlin in 1994 has a total mass of 145 kg, of which only 90 kg is accounted for by the metal alloy. The problem could be minimized by increasing the diameter of the individual pressure vessels (larger container volume). However, the required minimum wall thickness increases at the given maximum pressure and almost completely offsets the possible weight saving. In addition, the heat exchange becomes more difficult as the diameter increases, with the result that in practice, tube bundles consisting of individual pressure vessels in the diameter range between 50 and 120 mm have gained acceptance. However, the “round” geometry required due to the problems associated with pressure vessels does not meet the wishes of the users, who would like to integrate the tank (e.g. in motor vehicles) into complex cavities.

The object of the invention is to provide a light pressure vessel, which can be configured in a geometrically universal manner, for the housing of a hydrogen-storage alloy bed.

The object is achieved by a tank for the reversible storage of hydrogen, comprising an external pressure casing, a hydrogen-storage alloy contained therein, a heat-exchange system and a hydrogen-gas reservoir, which is characterized in that, for the absorption of the hydrogen-storage alloy, the tank has a bed which consists of an open-pored metal sponge which is connected to the pressure-vessel wall in a material fit.

The pressure vessel preferably consists of a metal or a metal alloy, and in particular the pressure vessel and the metal sponge consist of aluminium or an aluminium alloy. The porosity of the metal sponge is preferably between 50% and 90%.

In a preferred version of the invention, the pressure vessel consists of aluminium or an aluminium alloy and the metal sponge consists of magnesium or a magnesium alloy.

In a further preferred version, the hydrogen-storage tank is a tank for a vehicle powered by fuel cells.

In the drawings, there are shown in:

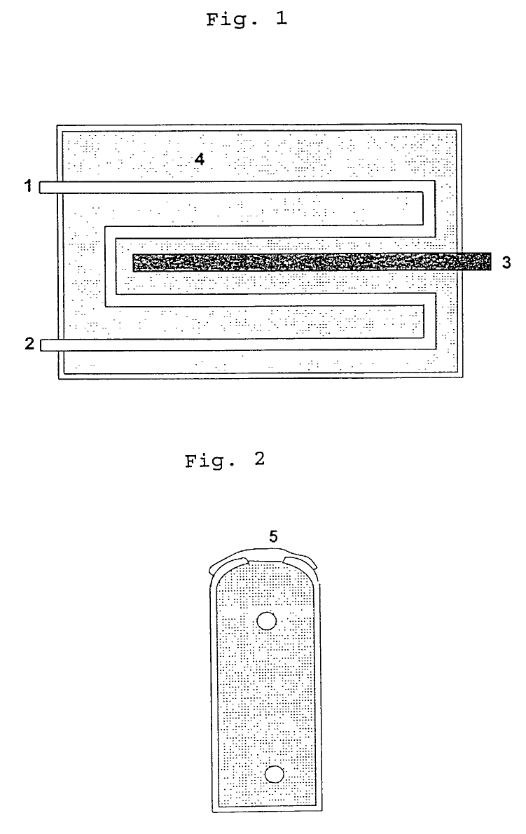

FIG. 1 a schematic representation of a hydrogen-storage tank according to the invention in cross-section, and

FIG. 2 a schematic representation of a hydrogen-storage tank according to the invention in longitudinal section.

The numbers 1 to 5 have the following meaning:

1 Cooling-water inlet

2 Cooling-water outlet

3 Hydrogen reservoir

4 Metal-alloy bed (open-pored metal sponge filled with metal-alloy powder

5 Half-shell closure (welded to metal casing)

The invention is based on the integration of an open-pored metal sponge with a large pore diameter into a thin-walled pressure vessel, preferably from the same metal material, designed with regard to the maximum pore diameter.

The integration is achieved by producing a receptacle, open at one side, from sheet metal and by preparing the metal sponge in this receptacle. As a result of the sponge-preparation process based on the metal-casting method, the sponge material is connected to the material of the vessel wall at the contact points, so that the resulting individual round pores, which are connected to each other by piercing points, meet the vessel wall only in “punctiform manner”. At the vessel wall, pressure conditions are thus established such as are present analogously in hollow spheres of the maximum pore diameter. With regard to pressure, the thickness of the vessel wall must be designed according to this diameter. The geometry of the entire vessel can be varied as desired, and this is the essence of the present invention.

As a result of the open-pored metal-sponge structure, the pressure conditions of a spherical form with a small diameter are adapted to a geometrically extended pressure vessel consisting of many such hollow spheres, in order that the vessel wall can be designed relatively thin, and furthermore an effective heat conduction is guaranteed both to the vessel wall and to integrated heat exchangers which can be poured into the structure during the casting process for the preparation of the sponge.

The tanks can also be produced according to the process described in DE-C-197 25 210. The contents of this patent specification are intended to be included here. In a preferred procedure, the storage means are created in a single casting process in which both the sponge structure and the vessel wall are developed. In further preferred versions, the metal sponge is connected to the pressure-vessel wall in a material fit by pouring liquefied metal against the wall, by welding or by soldering.

In particular aluminium, magnesium, iron, nickel, copper, zinc, lead, tin and their alloys can be considered as metals or metal alloys for the metal sponge. Aluminium or magnesium and their alloys are preferably used as metal material.

Hydrogen-storage alloys can be divided into low-temperature and high-temperature alloys according to their working temperature. The low-temperature hydrides are thermodynamically less stable, i.e. the heats of reaction to be exchanged are clearly smaller than in the case of high-temperature hydrides. The most common basic types of low-temperature hydrogen-storage alloys with maximum storage capacities of roughly 2 wt-. % hydrogen are:

| | |
|---|---|
| AB alloys: | FeTi, LaNi |
| AB₂ alloys: | Zr(V,Mn)₂, Ti(V,Mn)₂ |
| AB₅ alloys: | LaNi₅, CaNi₅ |

High-temperature hydrides relevant in practice have Mg as their main constituent (MgH₂, Mg₂Ni) and have clearly higher storage capacities of up to 7.6 wt.- %. However, the necessary desorption temperatures of >200° C. and the comparatively high specific desorption energies currently limit practical use. An overview of the use of hydrogen-storage alloys is given by V. Güther and A. Otto in “Recent Developments in Hydrogen Storage Applications Based on Metal Hydrides”, J. of Alloys and Compounds 1999, 295, pages 889-892.

Further suitable hydrogen-storage alloys are described extensively in the state of the art. Any suitable hydrogen-storage alloy can be considered for the implementation of the present invention. Reference should be made here to the following patent specifications as representative examples: DE-C-30 31 471, DE-C-30 23 770, DE-C-31 51 712, DE-C-31 39 368 and U.S. Pat. No. 41,60,014. The hydrogen-storage alloys described in DE-C-34 11 011 are preferably used.

### EXAMPLE

An aluminium sheet is bent in the shape of a U, the ends being bent inwards in a semicircle shape and leaving an opening with a width of 50 mm. A metal sheet is welded into the limbs of the U on both sides to create a narrow receptacle half-open at the top. The length of the receptacle is 800 mm, the width 120 mm and the height 250 mm. There is welded into one of the welded side parts an aluminium pipe which meanders through the receptacle and is again led out at a second point of the same surface. The receptacle is filled with spherical spacers made from quartz sand mixed with a binder according to DE-C-197 25 210. The quartz sand spheres have a bimodal diameter distribution (roughly 30 mm and roughly 10 mm), so that a degree of fill of roughly 83% results. The cavities which form are cast with aluminium according to the cited patent specification. Through the casting heat which results, the binder system of the spacers is dissolved, allowing the quartz sand to be removed from the pores. Through melting, a firm material fit results at the contact points of the sponge with the wall and the heat exchanger.

The result is a thin-walled pressure receptacle with a flat geometry not previously realized for pressure receptacles. A hole is drilled centrally along the longitudinal axis into a side part and a gas reservoir introduced, welded to the walls and led outside. A hydrogen-storage alloy powder is shaken into the open-pored structure. Then the upper opening is welded to a half-shell of a thickness corresponding to the pressure conditions prevailing there (see FIGS. 1 and 2).

Roughly 60 kg of metal alloy (corresponding to roughly 960 g of hydrogen or 31 kWh) can be stored in the described tank. The net weight of the empty tank including heat exchanger and gas reservoir is only roughly 18.4 kg and is therefore clearly below the specific proportions by weight of conventional tanks.

In addition to the geometry which can be configured as desired, the tank has an internal heat conductivity between the metal-alloy bed and the heat-exchange medium that is considerably superior compared with those of a conventional design, with the result that the absorption and desorption rates for hydrogen, which are limited by the transfer of heat of reaction, can be increased.

1. Tank for the reversible storage of hydrogen, comprising an external pressure casing, a hydrogen-storage alloy contained therein, a heat-exchange system and a hydrogen-gas reservoir, characterized in that, for the absorption of the hydrogen-storage alloy, the tank has a bed which consists of an open-pored metal sponge connected to the pressure-vessel wall in a material fit.

2. Tank according to claim 1, characterized in that the pressure vessel consists of a metal or a metal alloy.

3. Tank according to one of claims 1 or 2, characterized in that the pressure vessel and the open-pored metal sponge consist of aluminium or an aluminium alloy.

4. Tank according to claims 1 or 2, characterized in that the pressure vessel consists of aluminium or an aluminium alloy and the metal sponge consists of magnesium or a magnesium alloy.

5. Tank according to at least one of claims 1 to 4, characterized in that the porosity of the metal sponge is between 50% and 90%.

6. Tank according to at least one of claims 1 to 5, characterized in that it is a tank for a motor vehicle powered by fuel cells.

7. Process for the manufacture of a tank according to claims 1 to 3, 5 and 6, characterized in that the storage means are prepared in a single casting process, in which both the sponge structure and the vessel wall are developed.

8. Process for the manufacture of a tank according to claims 1 to 6, characterized in that the metal sponge is connected to the pressure-vessel wall in a material fit by pouring liquefied metal against the wall.

9. Process for the manufacture of a tank according to claims 1 to 6, characterized in that the metal sponge is connected to the pressure-vessel wall in a material fit by welding.

10. Process for the manufacture of a tank according to claims 1 to 6, characterized in that the metal sponge is connected to the pressure-vessel wall in a material fit by soldering.
